(19) United States
(12) Patent Application Publication
(10) Pub. No.: US 2001/0002566 A1
(43) Pub. Date: Jun. 7, 2001

(54) PUNCH PRESS, SPECIFICALLY A HIGH-SPEED PUNCH PRESS

(76) Inventor: OSKAR EIGENMANN, ARBON (CH)

Correspondence Address: LADAS & PARRY, 26 WEST 61ST STREET, NEW YORK, NY, 10023, US

(21) Appl. No.: 09/262,702

(22) Filed: Mar. 4, 1999

(30) Foreign Application Priority Data
Apr. 30, 1998 (EP) 98 107 893-4

(51) Int. Cl. B26D 1/45

(52) U.S. Cl. 83/646; 83/647; 83/821

(57) ABSTRACT

Rods are supported on the drive shaft by self-aligning roller bearings such to be able to pendulate. The rods are pivotally mounted to the ram by ball-and-socket joints. At the area of the ball-and-socket joints the ram is guided by upper ram guides. These feature a degree of freedom for a movement in a direction of the web advancing direction of a web to be worked upon. Therefore, the upper tools remain aligned with the lower tools when an eccentric force acts onto the ram.

### BACKGROUND OF THE INVENTION

1. Field of the Invention

The present invention relates to a punch press, specifically a high-speed punch press, having a frame, at least one punch adapted to receive tools for a processing of a web-shaped material, which web-shaped material is fed in a stepwise fashion along a defined web-running plane in a defined web advancing direction, which press includes a drive shaft which extends parallel to the web advancing direction and is drivingly connected via drive members to the ram, which ram is guided in the press frame by upper ram guides at least at one location between the drive shaft and the web-running plane.

2. Description of the Prior Art

The person skilled in the art defines high-speed punch presses as machines which operate with stroke numbers up to and more than 1000 strokes/min, this in contrast to e.g. plate-cutting machines or filter presses which for instance find application in fruit processing plants. Punch presses include at least one ram for the receipt of a tool, which tools are commonly called upper tool, which upper tool co-operates with a further tool which is stationary with respect to the punch press frame and is commonly called lower tool.

By means of these tools a web, commonly a metal web, which is fed intermittently, step by step through the punch press is worked upon, i.e. processed. Thereby, punching, embossing and bending operations are performed, threads are formed, assembly work and welding operations (laser) are made, riveting work is done, just to mention a few of the working operations which are performed on such a web.

Regarding such punch presses, the art makes among others a distinction between transverse shaft punch presses and longitudinal shaft punch presses. The person skilled in the art defines the term “shaft” as to be the drive shaft of the machine, which drive shaft has e.g. eccentric sections or is designed as a crank shaft, which shaft is connected via driving members to a ram for the receipt of tools, which ram performs stroke movements with a number of strokes up to and more than 1000 strokes per minute in order to process or operate upon, respectively a web which is fed or advances, respectively, step by step in a so-called web advancing direction.

If the drive shaft extends parallel to the web advancing direction, the person skilled in the art refers to a longitudinal shaft punch press. If the drive shaft extends laterally to the web advancing direction, the person skilled in the art refers to a transverse shaft punch press.

The rams of the high-speed punch presses which perform in operation a stroke movement are commonly guided by linear circular guides, i.e. the guiding members have a circular cross-section. Linear circular guides are designed as sliding guides or as roller bearing guides.

Basically, always two guiding planes are present. A guiding plane is commonly defined as a plane which is defined by the locations of the guides.

This is to be understood as follows:

The ram is rigidly mounted to guiding columns, via which guiding columns the ram is guided in the frame of the punch press. The location of the guides, i.e. the guiding members mounted in the frame, defines a first guiding plane.

The drive shaft is connected via rods to the punch. The punch is now guided at a further location, namely at a location between ram and drive shaft, i.e. above the web-running plane, such that accordingly a second guiding plane is defined. These upper guides absorb, thereby, mainly the forces of the rods stemming from the dynamics of the machine when it is running, and from the processing, i.e. punching operation.

All of the above guides are so-called circular guides.

In case of an eccentric (relative to the direction of advance of the web) punching load, i.e. a force acting onto an eccentric location of the punch, the driving members of the machine, e.g. rods are differently loaded and deformed, which leads positively to an oblique position of the ram. Differently loaded is to be understood in the sense that one of the rods is subject to larger forces than the other rod, depending from the location of the (eccentric) force acting onto the ram. An obliquely positioned ram causes a change of the locations or positions, respectively, of the tools. The tools (i.e. upper tool and lower tool) must be aligned in an extremely precise manner relative to each other because the working is made in tolerances of 1/1000 millimeters. In case of e.g. a corresponding small cutting clearance between a punch and a lower die, a deflection of e.g. a punch will lead to a higher wear in the tool or to a breaking off of sections or a chiselling off, respectively, at the punch. Tools are extremely expensive and a re-grinding or replacing of tools obviously cause loss of production. Thus, the mentioned incidents occurring at an oblique position of the ram lead to extremely high financial losses.

The tilting or pivoting, respectively, movement of the ram in case of an eccentric loading of the ram obviously proceeds around a center of rotation, i.e. the center of the tilting or pivoting, respectively, movement.

If now the center of the tilting movement of the ram is located in the web-running plane, i.e. coincides therewith, the above drawbacks do not occur. If, however, the center of the tilting movement of the ram is located adjacent said plane, at a distance therefrom, the above mentioned drawbacks occur in a large, very serious extent. The center of the tilting movement of the ram coincides, however, with the web-running plane only when no further guides are present above the web-running plane, i.e. between the web-running plane and the drive shaft, which would prevent a tilting or pivoting movement of the ram.

The punch presses structured in accordance with the prior art having a drive shaft what extends parallel to the web advancing direction, i.e. so-called longitudinal shaft punch presses, feature a ram tilting center which is always located between the upper and the lower plane of guidance as described above, i.e. above the web-running plane, wherewith the above disadvantages occur.

### SUMMARY OF THE INVENTION

It is, therefore, a general object of the invention to provide a punch press with a drive shaft which extends parallel to the direction of advance of the web to be worked upon in the press, i.e. a so-called longitudinal shaft punch, in which the upper ram guides feature a degree of freedom of their movement in the web advancing direction, such that no high wear, no chafing and no breaking off of portions in the tools will occur.

The advantages gained by the invention are mainly to be seen in that the center of the tilting movement of the ram will be located in the plane of advance of the web, wherewith in case of an oblique orientation of the ram neither wear nor a breaking off of portions of the tools will occur.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a view of a longitudinal section through a longitudinal shaft punch press;

FIG. 2 is a section along line II-II of FIG. 1;

FIG. 3 is a section along line III-III of FIG. 1;

FIG. 4 represents a so-called wire model of the driving members of the ram at a time prior to the beginning of the operation, i.e. without any acting forces;

FIG. 5 illustrates the wire model of FIG. 4 during a punching operation and at an eccentrically acting force.

### DETAILED DESCRIPTION OF THE PREFERRED EMBODIMENT

For the sake of clarity, the figures illustrate only those structures of the longitudinal shaft punch press which are necessary for the understanding of the invention. Not illustrated are specifically the drive encompassing the motor and the brake/clutch apparatus, the structures for adjusting the height position of the ram, and all balancing weight structures and their driving members for the well known balancing of the mass forces. These structures are known by the person skilled in the art and, therefore, must not be described in detail.

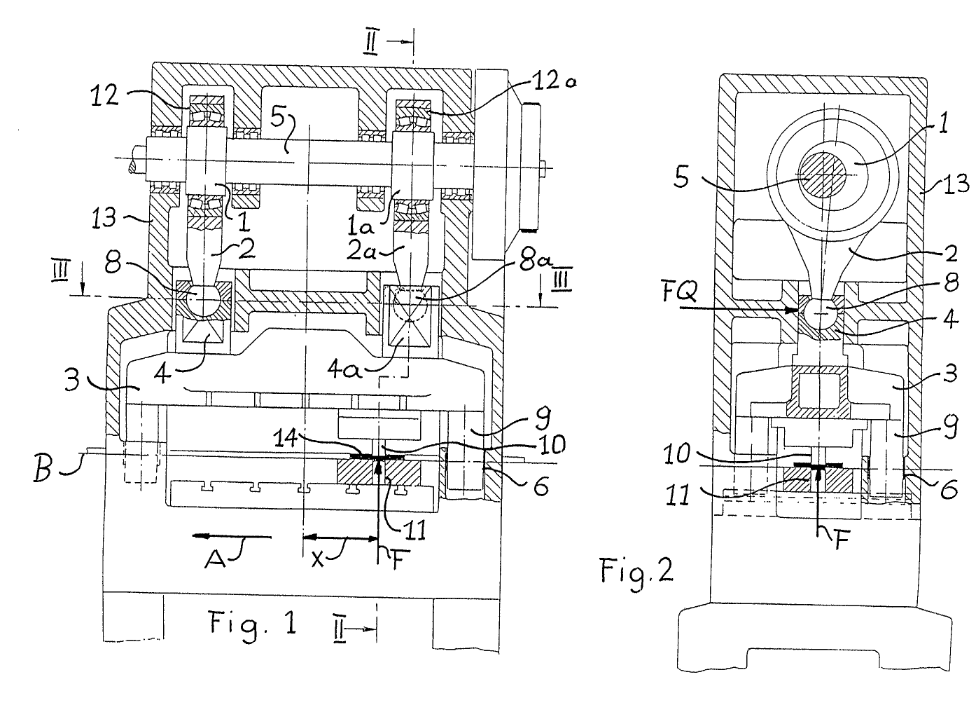

The drive shaft 5 which is shown in FIGS. 1 and 2 is supported in the machine frame 13 and includes two eccentric sections 1, 1a. Rods 2, 2a are supported on these eccentric sections 1, 1a via self-aligning roller bearings 12, 12a such to be able to pendulate.

It can be thus seen that the rods 2, 2a are free to pivot or pendulate, respectively, in a direction parallel to the longitudinal direction of the drive shaft 5.

At their ends remote from the self-aligning roller bearings 12, 12a the rods 2, 2a are pivotally mounted to the ram 3 by means of ball-and-socket joints 8, 8a. These ball-and-socket joints 8, 8a are in turn arranged in guides 4, 4a of the ram 3. As can be clearly seen, these guides 4, 4a are located at a location between the ram 3 and the drive shaft 5, i.e. above the ram 3. The person skilled in the art identifies these guides 4, 4a as upper ram guides.

As can be specifically seen in FIG. 2, these guides 4, 4a, thus the upper ram guides, perform a guiding of the ram 3 for movement in the direction of the stroke, with restrictions, such as will be explained further below.

The ram 3 has four guiding columns which are generally identified by the reference numeral 9. These guiding columns 9 are rigidly mounted to the ram 3 and are guided in circular guides 6 that are mounted to the machine frame 13. The term “circular guide” is to be understood as meaning that the cross-section of the guiding columns 9 and the cross-section of the inner space of the circular guides 6 have a circular shape, which means that the ram 3 is free to move in the direction of its stroke and is restricted against any movement perpendicularly to the direction of its stroke. The art calls these guides described above the lower ram guides.

The ram 3 carries a variety of tools of which, as example, a punch 10 is illustrated in the drawings. This punch 10 co-operates with a lower die 11 which is stationary relative to the machine frame 13 such as known to the person skilled in the art.

FIG. 1 shows, furthermore, the web-running plane B. The web-running plane B is here defined as the plane of contact between the lower side of the web 14 being processed and the upper side of the die 11 on which the web 14 rests.

For the sake of clarity, only a portion of the metal web 14 is shown in the figures, namely that portion of the metal web 14 which rests directly on the lower die, which portion is illustrated by a thick line.

The web advancing direction, i.e. the direction of the feed of the step-by-step feeding of the metal web, is identified by the arrow A.

As can be seen, the drive shaft 5 extends parallel to the web advancing direction A, and for this reason the punch press under consideration here is called “longitudinal shaft punch press”.

Reference is now again made to the guides in the punch press.

In contrast to the lower ram guides 6, 9 which are designed as circular guides, the upper ram guides 4, 4a are designed as planar guides, i.e. their guiding surfaces are planar.

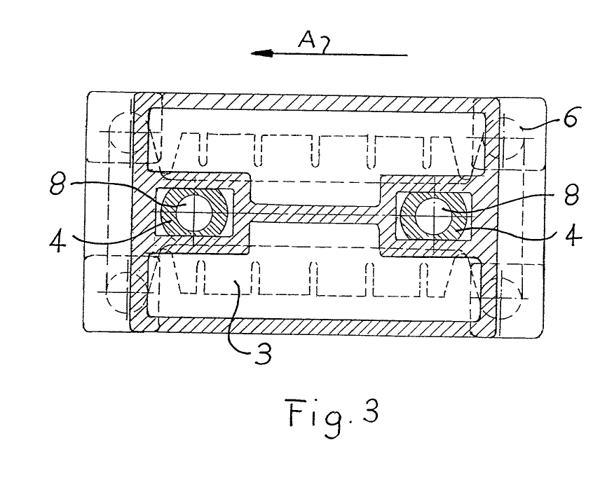

Such as can be seen in FIGS. 1 to 3, the upper ram guides 4, 4a feature a degree of freedom in the web advancing direction A. Specifically FIGS. 1 and 3 show that these ram guides 4, 4a and accordingly the lower ends of the rods 2, 2a can move at the ball-and-socket bearing 8 in the web advancing direction A.

However, a perpendicular or also oblique movement relative to the web advancing direction is not possible, such as can be clearly seen in FIGS. 2 and 3; any resulting forces FQ (see FIG. 2) acting transversely to the web advancing direction A are taken up by the ram guides 4, 4a, i.e. by the planar guides.

It shall now be assumed that an eccentric load F acts onto the ram at a distance X from the center of the ram 3, such as illustrated in FIG. 1. During an initial punch operation, i.e. just when a leading edge portion of the web has been inserted between the upper and lower tools, such eccentric loading F always occurs; this is a basic fact.

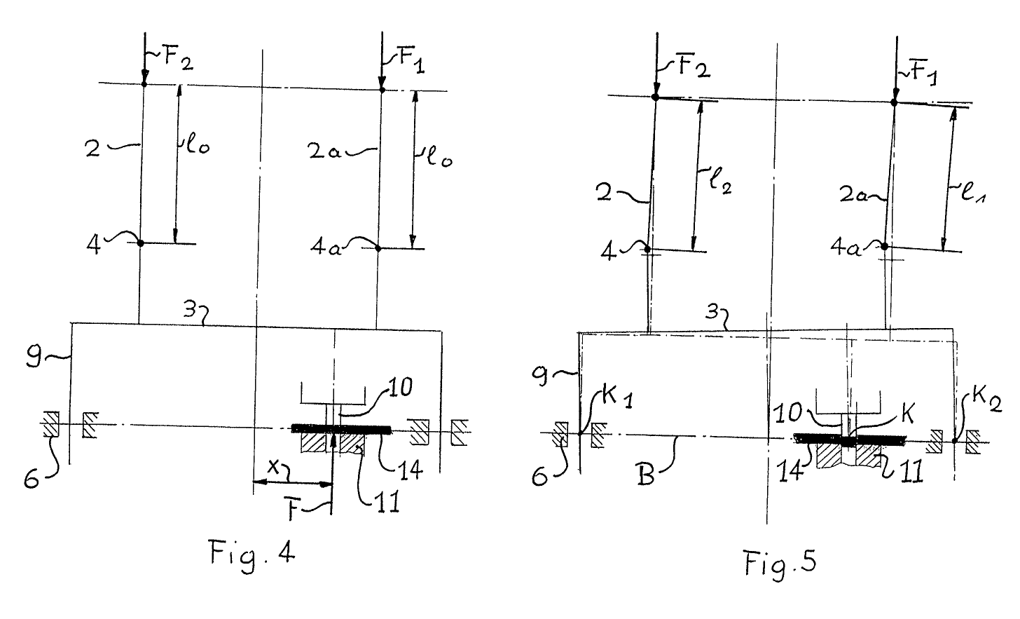

Attention is now drawn to the wire models of FIGS. 4 and 5. The structural members which will now be discussed are represented or shall be thought of as wires for ease of understanding the explanation.

FIG. 4 illustrates the structural members, i.e. rods 2, 2a and ram 3, in a position at which a first contact between the punch 10 and the metal web 14 on the lower die takes place. F₁ and F₂ represent the loadings of the driving members, among others, of the rods 2, 2a. FIGS. l_{O} illustrate the vertical lengths of the rods.

In this instance the eccentric force F has the value F=0.

Attention is now drawn to FIG. 5. When the punch 10 impacts the metal web 14, the ram 3 will begin to pivot or tilt, respectively, around the point K, the tilting point, i.e. center of this pivoting movement, and will tilt from the position illustrated by dash-dotted lines into the position illustrated by solid lines. (The extent of the shifting of the position of the ram 3 is strongly exaggerated in FIG. 5).

Because the guides 4, 4a can now move laterally, the rods 2, 2a (the lengths of the rods 2, 2a are identified by l₁, l₂) will pivot into the illustrated positions. Also the loading forces F₁ and F₂ of the drive members become to differ from each other.

At eccentric loadings not only a tilted position of the ram occurs; it is also possible that small deformations occur which nevertheless influence the precision of the work and the products. Therefore, the ram 3 is preferably guided also at the guiding columns 9 in the plane of advance B of the web. And, therefore, the punch 10 remains aligned with the lower die 11.

Obviously, the illustrated embodiment is not confined to punch presses having one ram only. It is also possible to equip punch presses having a plurality of rams with guides structured in accordance with the invention.

While there is shown and described a present preferred embodiment of the invention, it is to be distinctly understood that the invention is not limited thereto, but may be otherwise variously embodied and practised within the scope of the following Claims.

1. A punch press, specifically a high-speed punch press having a frame, at least one punch adapted to receive tools for a processing of a web-shaped material, which web-shaped material is fed in a stepwise fashion along a defined web-running plane in a defined web advancing direction, which press includes a drive shaft that extends parallel to the web advancing direction and is drivingly connected via drive members to the ram, which ram is guided in the press frame by upper ram guides at least at one location between the drive shaft and the web-running plane;
wherein said upper ram guides feature a degree of freedom of their movement in the web advancing direction.

2. The punch press of claim 1, in which the ram is guided by lower ram guides in the web-running plane for movement in a direction of the stroke of the ram.

3. The punch press of claim 1, in which the drive members include rods which at one of their ends are eccentrically supported on the drive shaft and which at their opposite ends are pivotally mounted to the ram by means of respective ball-and-socket joints.

4. The press punch of claim 1, in which the drive members include rods which are supported at one of their ends on the drive shaft in a pendulum-like manner, such to be able to pendulate in a direction of the web advancing direction.

5. The punch press of claim 1, in which the drive members include rods which are supported at one of their ends by self-aligning roller bearings on the drive shaft in a pendulum-like manner, such to be able to pendulate in the direction of the web advancing direction.
